(19) United States
(12) Patent Application Publication
(10) Pub. No.: US 2025/0307730 A1
(43) Pub. Date: Oct. 2, 2025

(54) INFORMATION PROCESSING DEVICE, CONTROL METHOD, AND STORAGE MEDIUM

(71) Applicant: NEC Corporation, Tokyo (JP)

(72) Inventors: Tatsuya MATSUOKA, Tokyo (JP); Kei TAKEMURA, Tokyo (JP)

(73) Assignee: NEC Corporation, Tokyo (JP)

(21) Appl. No.: 19/070,589

(22) Filed: Mar. 5, 2025

(30) Foreign Application Priority Data
Mar. 28, 2024 (JP) 2024-053203

(51) Int. Cl. G06Q 10/04; G06F 17/18

(52) U.S. Cl. CPC G06Q 10/04; G06F 17/18

(57) ABSTRACT

The information processing device 1X mainly includes an acquisition means 15Xa, a first determination means 15Xb, a selection means 15Xc, an observation means 15Xd, and a second determination means 15Xe. The acquisition means 15Xa acquires a feedback graph representing an online optimization problem. The first determination means 15Xb determines, based on the feedback graph, a probability distribution for selecting an action to be taken from action candidates. The selection means 15Xc selects the action based on the probability distribution. The observation means 15Xd observes a loss based on the action. The second determination means 15Xe determines, based on the observed loss, a weight for determining the probability distribution.

### INCORPORATION BY REFERENCE

This application is based upon and claims the benefit of priority from Japanese Patent Application No. 2024-053203, filed on Mar. 28, 2024, the disclosure of which is incorporated herein in its entirety by reference.

### TECHNICAL FIELD

The present disclosure relates to a technical field of an information processing device, a control method, and a storage medium for performing processing related to an online optimization problem.

### BACKGROUND

A system to determine an optimal action is known. For example, Patent Literature 1 discloses a technique of determining the optimum action in consideration of risks for each state in each unit period which can transition according to a predetermined transition probability when a predetermined action over each unit period during a target period.

### CITATION LIST

### Patent Literature

Patent Literature 1: JP 2012-068780A

### SUMMARY

In the on-line optimization problem where sets of observation and action are performed sequentially, a static regret can be used as the representative objective function. On the other hand, according to a static regret, the target action of comparison with the action to be determined for each round is assumed to be a fixed action at each round, so it could occur that the determined action is not the best action nor the similar action to the best action.

In view of the above-described issues, one object of the present disclosure is to provide an information processing device, a control method, and a storage medium capable of suitably determining an action to be executed.

In an example aspect of the present disclosure, there is provided an image processing device including:
an acquisition means configured to acquire a feedback graph representing an online optimization problem;
a first determination means configured to determine, based on the feedback graph, a probability distribution for selecting an action to be taken from action candidates;
a selection means configured to select the action based on the probability distribution; an observation means configured to observe a loss based on taking the action; and
a second determination means configured to determine, based on the loss, a weight for determining the probability distribution.

In an example aspect of the present disclosure, there is provided a control method executed by a computer, including:
acquiring a feedback graph representing an online optimization problem;
determining, based on the feedback graph, a probability distribution for selecting an action to be taken from action candidates;
selecting the action based on the probability distribution;
observing a loss based on taking the action; and
determining, based on the loss, a weight for determining the probability distribution.

In an example aspect of the present disclosure, there is provided a storage medium storing a program executed by a computer, the program causing the computer to:
acquire a feedback graph representing an online optimization problem;
determine, based on the feedback graph, a probability distribution for selecting an action to be taken from action candidates;
select the action based on the probability distribution;
observe a loss based on taking the action; and
determine, based on the loss, a weight for determining the probability distribution.

An example advantage according to the present disclosure is to suitably output information in consideration of relaxation of constraints.

### BRIEF DESCRIPTION OF THE DRAWINGS

FIG. 1 It illustrates a configuration of an optimization system.

FIG. 2 It illustrates a hardware configuration of an information processing device.

FIG. 3 It illustrates an example of functional blocks of the processor of the information processing device.

FIGS. 4A and 4B FIG. 4A illustrates an example of full-information feedback setting.

FIG. 4B illustrates an example of bandit feedback setting.

FIGS. 5A to 5C FIG. 5A illustrates an example of a feedback graph which is strongly observable.

FIG. 5B illustrates an example of a feedback graph which is weakly observable.

FIG. 5C illustrates an example of a feedback graph which is neither strongly observable nor weakly observable.

FIG. 6 It is an example of a flowchart showing a processing procedure based on the present disclosure algorithm.

FIG. 7 It is a feedback graph showing an applicable example of the opportunity loss in the retailer sales.

FIG. 8 It illustrates a configuration of the optimization system.

FIG. 9 It illustrates a functional block diagram of the information processing device.

FIG. 10 It illustrates an example of a flowchart showing a processing procedure of the information processing device.

### EXAMPLE EMBODIMENTS

Hereinafter, embodiments of an information processing device, a control method, and a storage medium will be described with reference to the drawings.

### First Example Embodiment

### (1) System Configuration

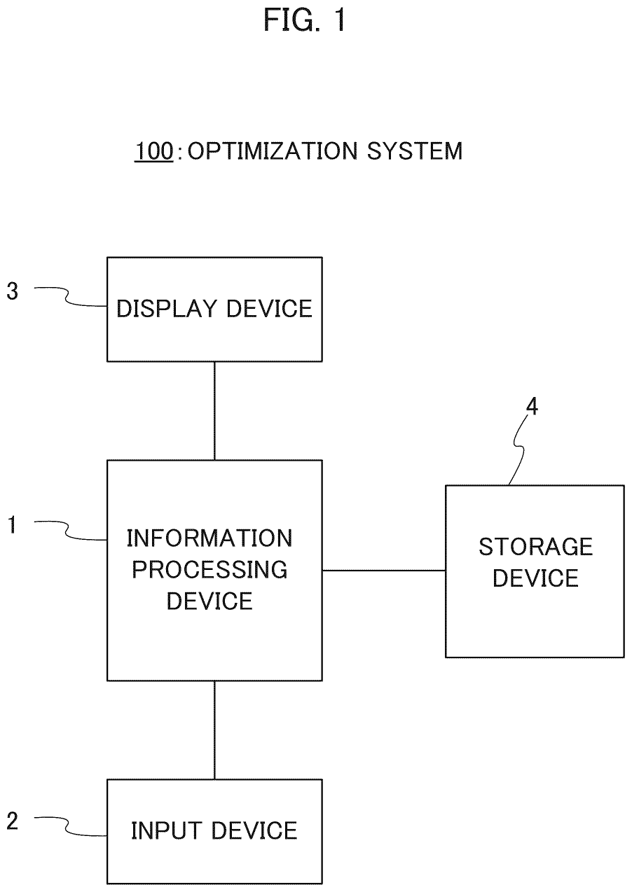

FIG. 1 illustrates a configuration of an optimization system 100 that performs processing related to online optimization. The optimization system 100 mainly includes an information processing device 1, an input device 2, a display device 3, and a storage device 4.

The information processing device 1 calculates a solution of the specified online optimization problem and outputs the calculated solution. The online optimization problem is a modeled problem of a situation in which decision making and observation of a result are alternatively repeated under an uncertain environment, and the information processing device 1 in the present embodiment sequentially performs a set of observation and determination of an action to be executed. Examples of application examples of the online optimization problem in the present example embodiment include any example in which a general online optimization problem can be applied, and include, for example, a problem of price setting of products by observing sales of products, and a problem related to learning and education. Specific application examples of the online optimization problem in the present embodiment will be described later.

Further, the information processing device 1 performs data communication with the input device 2, the display device 3, and the storage device 4 through a communication network or through wireless or wired direct communication.

The input device 2 is an interface for receiving a user input that is an external input, and examples of the input device 2 include a touch panel, a button, a keyboard, and a voice input device. The input device 2 supplies the input information generated based on the input from the user to the information processing device 1.

The display device 3 displays information based on display information supplied from the information processing device 1, and examples of the display device 3 include a display and a projector.

The storage device 4 is one or more memories for storing various information necessary for optimization processing. For example, the storage device 4 stores information (also referred to as “problem specification information”) which specifies the online optimization problem to be solved by the information processing device 1 and a program for calculating the solution of the specified online optimization problem. The problem specification information includes at least information indicating the setting of the feedback graph of the online optimization problem to be solved by the information processing device 1. The feedback graph will be described later. In addition, the problem specification information may include parameters (including information relating to the objective function and constraint conditions) necessary for identifying the online optimization problem. At least a part of the problem specification information may be generated based on the input information generated by the input device 2 subject to operation by the user.

The storage device 4 may be a storage device such as a hard disk connected or built in to the information processing device 1, or may be a storage medium such as a flash memory. The storage device 4 may be one or more server devices that performs data communication with the information processing device 1. In this case, the storage device 4 may be comprised of a plurality of server devices.

The configuration of the optimization system 100 shown in FIG. 1 is an example, and various changes may be made to the configuration. For example, the input device 2 and the display device 3 may be configured integrally. In this case, the input device 2 and the display device 3 may be configured as a tablet terminal that is integrated with the information processing device 1. Further, the information processing device 1 may be connected to or incorporate a sound output device such as a speaker for outputting sound, and may output information by audio. Further, the information processing device 1 may be configured by a plurality of devices. In this case, the plurality of devices constituting the information processing device 1 exchange information necessary for executing preassigned processing among the plurality of devices.

### (2) Hardware Configuration of Information Processing Device

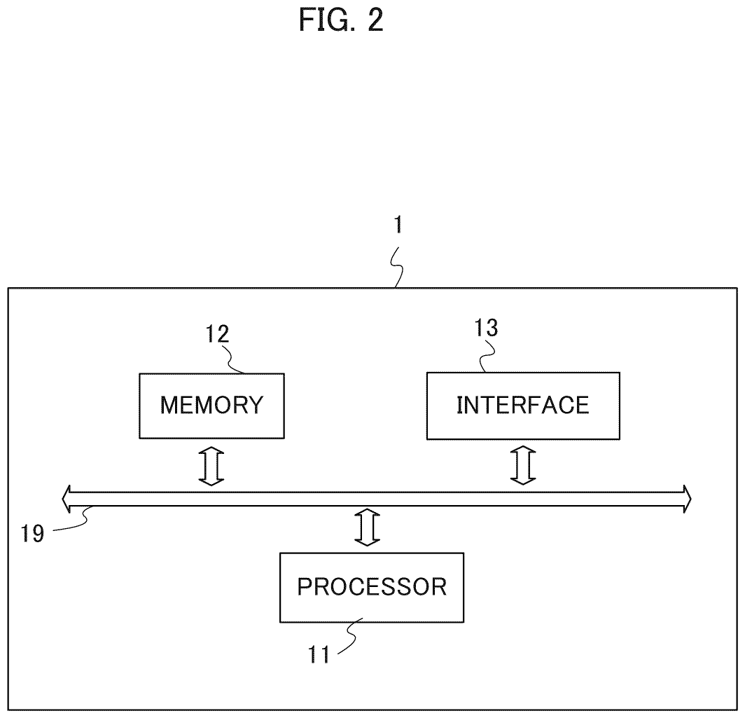

FIG. 2 shows a hardware configuration of the information processing device 1. The information processing device 1 includes a processor 11, a memory 12, and an interface 13 as hardware. The processor 11, the memory 12 and the interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured of a plurality of processors. The processor 11 is an example of a computer.

The memory 12 is configured by various volatile memories and non-volatile memories such as a RAM (Random Access Memory) and a ROM (Read Only Memory). Further, a program for the information processing device 1 to execute various kinds of process is stored in the memory 12. The memory 12 is used as a working memory to temporarily store information and the like acquired from the storage device 4. The memory 12 may function as a storage device 4. The storage device 4 may function as the memory 12 of the information processing device 1. The program executed by the information processing device 1 may be stored in a storage medium other than the memory 12.

The interface 13 is one or more interfaces for electrically connecting the information processing device 1 to other devices. Examples of the interfaces include a wireless interface, such as a network adapter, for transmitting and receiving data to and from other devices wirelessly, and a hardware interface, such as a cable, for connecting to other devices.

The hardware configuration of the information processing device 1 is not limited to the configuration shown in FIG. 2. For example, the information processing device 1 may incorporate at least one of the input device 2 and/or the display device 3. In another example, the information processing device 1 may incorporate or be connected to a sound output device such as a speaker.

### (3) Functional Blocks

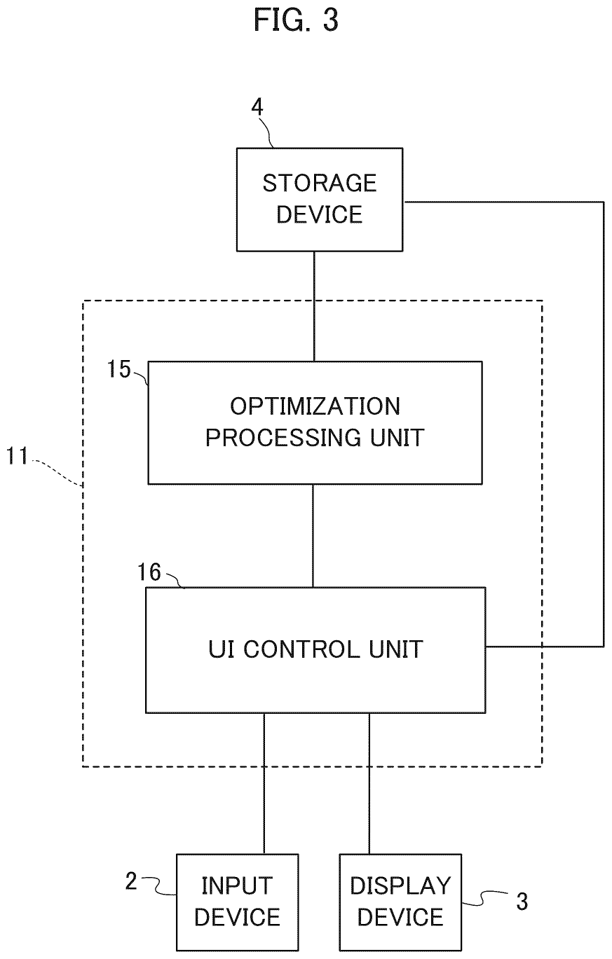

FIG. 3 illustrates an example of functional blocks of the processor 11. The processor 11 functionally includes an optimization processing unit 15 and a UI (User Interface) control unit 16. In FIG. 3, any blocks configured to exchange data with each other are connected by a solid line, but the combination of blocks configured to exchange data with each other is not limited to FIG. 3. The same applies to the drawings of other functional blocks described below.

The optimization processing unit 15 generates a solution of the specified online optimization problem. Then, the optimization processing unit 15 supplies the information generated by the optimization processing unit 15 to the UI control unit 16. Details of the processing in the optimization processing unit 15 will be described later.

The UI control unit 16 receives the user input and controls the display of the information to be viewed by the user. In this instance, the UI control unit 16 may acquire information required for generating the problem specification information based on the input information supplied from the input device 2. Further, the UI control unit 16 generates the display information on the basis of the information (e.g., information regarding the determined action) generated by the optimization processing unit 15. Then, the UI control unit 16 supplies the generated display information to the display device 3 to thereby perform the display control of the display device 3. Specific processes executed by the UI control unit 16 will be described later with reference to display examples. The UI control unit 16 functions as a display control unit.

The optimization processing unit 15 and the UI control unit 16 described in FIG. 3 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using a user programmable integrated circuit such as a FPGA (Field-Programmable Gate Array) and a microcontroller. In this case, the integrated circuit may be used to realize a program to function as each of the above components. Further, at least some of the components may be realized by ASSP (Application Specific Standard Produce), ASIC (Application Specific Integrated Circuit), or quantum processor (quantum computer control chip). Thus, each component may be implemented by various hardware. The above is also true for other example embodiments described later. Furthermore, each of these components may be implemented by the cooperation of a plurality of computers, for example, using cloud computing technology.

### (4) Processing in Optimization Processing Unit

Next, a description will be given of the processing in the optimization processing unit 15. The optimization processing unit 15 sets a feedback graph representing a given online optimization problem and obtains a solution by dynamic regret using the set feedback graph.

First, a description will be given of the setting of the feedback graph.

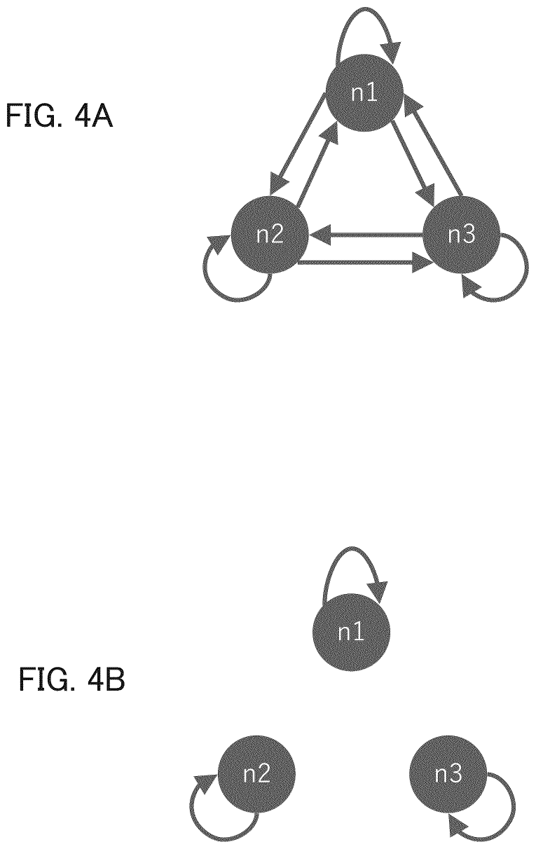

FIG. 4A illustrates an example of a full-information feedback setting, and FIG. 4B illustrates an example of a bandit feedback setting. In FIGS. 4A and 4B, candidates (also referred to as “action candidates”) for the action to be taken are represented by three vertices (vertex n1, vertex n2, and vertex n3). Here, full-information feedback setting has a graph structure, as shown in FIG. 4A, in which feedback is obtained for every candidate of the action, while the bandit feedback setting has a graph structure, as shown in FIG. 4B, in which feedback is obtained only for the action having been taken. The feedback graph shows the relation in which the feedback of the action of the vertex corresponding to the start point (Head) of the branch is obtained once the action of the vertex corresponding to the end point (Tail) of the branch is taken.

The full-information feedback setting and the bandit feedback setting described above may be regarded as specific cases of the feedback setting, and any other feedback setting may be applied.

As described above, the setting of the feedback graph is determined depending on whether or not a branch between a pair of vertices exists and whether or not a self-loop exists at each vertex. Then, when the online optimization problem is specified, the number of vertices, the branches (and their orientations) between each pair of the vertices, and whether a self-loop exists or not at each vertex are uniquely determined by the specified online optimization problem. In the present example embodiment, it is assumed that the problem specification information includes information indicating the setting of the feedback graph representing the online optimization problem to be solved.

The details of the setting of the feedback graph used for the online optimization problem, for example, is disclosed in the following literature. It is noted that the last letter of “Nicolo” is a letter with “'” above “o”.

Noga Alon, Nicolo Cesa-Bianchi, Ofer Dekel, and Tomer Koren. Online learning with feedback graphs: beyond bandits. In arXiv preprints, arXiv:1502.07617, 2015.

Here, feedback graphs can be classified into “strongly observable”, “weakly observable”, and “others”. As will be described later, the optimization processing unit 15 appropriately determines a probability distribution for selecting an action depending on whether the feedback graph representing the online optimization problem to be solved is strongly observable or weakly observable. In addition, the performance assessment when the feedback graph corresponds to either strongly observable or weakly observable will be described later. The algorithm of the present example embodiment is applicable to a feedback graph that is not classified into any of these.

Here, “the feedback graph is strongly observable” refers to a feedback graph where each vertex v∈V satisfies one of the following conditions (a) and (b), wherein “V” denotes the vertex set of the feedback graph,
(a) v has a self-loop,
(b) There is a branch between v and every vertex other than v.

On the other hand, “feedback graph is weakly observable” refers to a feedback graph which is not strongly observable and in which there is no vertex which all branch (including self-loop) does not enter.

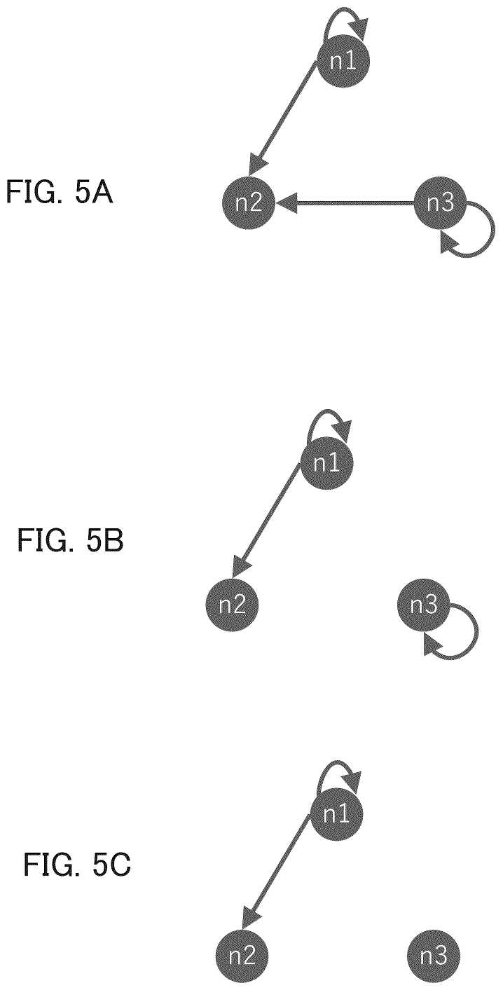

FIG. 5A shows an example of a feedback graph being strongly observable, FIG. 5B shows an example of a feedback graph being weakly observable, FIG. 5C shows an example of a feedback graph that does not correspond to any of strongly observable or weakly observable.

In the feedback graph shown in FIG. 5A, the vertex n1 and the vertex n3 have self-loops (i.e., the condition (a) is satisfied), respectively, and there are branches from all vertices (i.e., vertex n1 and vertex n3) other than the vertex n2 to the vertex n2 (i.e., the condition (b) is satisfied). Therefore, the feedback graph shown in FIG. 5A is strongly observable. The feedback graph shown in FIG. 5B is not strongly observable since the vertex n2 does not satisfy any of the above condition (a) and condition (b). On the other hand, the feedback graph shown in FIG. 5B is weakly observable because there is no vertex which all branch (including self-loop) does not enter. The feedback graph shown in FIG. 5C is not strongly observable since the vertex n2 and the vertex n3 do not satisfy any of the above-described condition (a) and condition (b). Besides, the feedback graph shown in FIG. 5C is not weakly observable because the vertex n3 has no coming branch (including self-loop).

Next, a description will be given of the dynamic regret. The dynamic regret refers to an objective function that indicates the difference between the loss sum of the sequence of the determined actions and the loss sum of the sequence of the variable best actions. Here, the “variable best actions” described above are a sequence of the actions to be compared with the sequence of the determined actions, and are variable for each round (i.e., the cycle at which the action is executed). In contrast, the static regret refers to an objective function that indicates the difference between the loss sum of the sequence of the determined actions and the loss sum of the sequence of the fixed best actions. In other words, according to the static regret, the sequence of actions to be compared with the sequence of the determined actions is fixed without changing at each round.

The details of the dynamic regret, for example, are disclosed in the following literature. Mark Herbster and Manfred K. Warmuth. Tracking the best expert. Machine Learning, 32(2):151-178, 1998.

Next, details of an algorithm (also referred to as “present disclosure algorithm”) for determining actions based on a feedback graph and dynamic regret will be described. The present disclosure algorithm is an algorithm configured to output a sequence of actions (I₁, . . . , I_{T}∈[K], where T is an integer greater than or equal to 1) to be taken when the parameters γ, η, and β are entered thereto. The term “[K]” represents a set of possible actions. In addition, the parameters γ, η, and β are hyperparameters larger than 0, respectively, and may be determined by input information supplied from the input device 2, or may be previously stored in the storage device 4 or the memory 12.

First, the optimization processing unit 15 sets the weight “w₁” for each action candidate used for determining the action I₁ at the first round to 1, which is the initial value. Namely, when the index of an action candidate is set to “i≠[K]”, the optimization processing unit 15 sets the weight w₁(i) for the action candidate i at the first round as follows.
w₁(i)=1 for all i∈[K]

Further, upon determining that the feedback graph representing the online optimization problem to be solved is strongly observable, the optimization processing unit 15 regards a probability distribution “u” to be described later as a uniform distribution on the set [K]. On the other hand, upon determining that the feedback graph representing the online optimization problem to be solved is weakly observable, the optimization processing unit 15 regards the probability distribution u as a uniform distribution on the smallest weakly dominating set “D”. Thus, the optimization processing unit 15 determines the probability distribution u, based on the classification of the feedback graph.

A set of vertices is a weakly dominating set if the destination vertices of branches originated from the set of vertices contain all weakly-observable vertices of the graph. A vertex is weakly observable if the vertex has at least one branch coming in the vertex from at least one vertex although the vertex does not have a self-loop and not all branches from the vertices other than itself do not come in the vertex.

Then, the optimization processing unit 15 executes the following processes (first process to sixth process), in order, for t=1, 2, . . . , T, wherein “t” denotes the index of the target round of calculation and “T” denotes the total number of rounds.

First, as the first process, the optimization processing unit 15 sets the probability distribution pₜ at the target round t according to the following equation (1), using the weight wₜ (all 1 in the case of t=1), a probability distribution u according to the classification of the feedback graph, and the parameter γ.

$${p}_{t} = ( 1 - γ ) \frac{{w}_{t}}{{W}_{t}} + γ u \qquad ( 1 )$$

Here, “wₜ” is the sum of the weights wₜ of K action candidates, and is expressed as follows.

$${W}_{t} = {\sum }_{i = 1}^{K} {w}_{i} ( t )$$

The weight wₜ is the setting of the feedback graph, and in the present disclosure algorithm, as will be described later, the weight wₜ that is a part of the setting of the feedback graph is updated on a round-by-round basis.

As the second process, the optimization processing unit 15 probabilistically selects the action Iₜ to be taken at the t-th round in accordance with the probability distribution pₜ. In this instance, the optimization processing unit 15 performs an extraction “Draw” of the action to be
Draw Iₜ˜pₜ

As the third process, the optimization processing unit 15 acquires the loss “lₜ(Iₜ)” generated by taking the action Iₜ determined through the second process in accordance with the feedback graph. It is herein assumed that the loss lₜ(Iₜ) is normalized to be in the range of 0 to 1. The optimization processing unit 15 may acquire the information regarding the loss based on the input information generated by the input device 2 based on the user's operation, or may acquire the information by receiving the information from a device (e.g., a POS terminal or the like when the loss is based on the sales) other than the information processing device 1. In this case, the optimization processing unit 15 performs “Receive” which indicates the reception of the loss lₜ(Iₜ) as follows.
Receive lₜ(Iₜ)∈[0, 1]

As the fourth process, the optimization processing unit 15 observes the losses caused by taking respective action candidates which can be fed back from the executed action Iₜ. Given that “lₜ(i)” denotes the loss caused by taking the action candidate i at the t-th round and that “N^{out}(Iₜ)” denotes the set of other vertices to which the branches from the vertex of the executed action Iₜ connects, the optimization processing unit 15 executes the following “Observe” which indicates observation as the third process.
Observe {(i, lₜ(i))|i∈N^{out}(Iₜ)}

In this case, the optimization processing unit 15 may calculate the loss lₜ(i) of any action candidate belonging to the set N^{out} in any way using the result of the executed action Iₜ. For example, for each branch of the feedback graph, calculation information (e.g., formulas or look-up tables) is stored in the storage device 4 or the memory 12 for deriving the loss of the action of the vertex that is the tail of a branch from the action result (e.g., loss) of the vertex that is the head of the branch. Then, the optimization processing unit 15 derives the losses regarding respective action candidates belonging to the set N^{out} from the executed action Iₜ on the basis of the calculation information.

As the fifth process, the optimization processing unit 15 calculates, based on the equation (1) and the observed loss lₜ, the loss “l\hat{ }ₜ(i)” which is used for updating the weight for each action candidate i using the probability distribution pₜ, as follows. Hereinafter, the loss lₜ observed in the third process and the fourth process is referred to as “first loss”, and the loss l\hat{ }ₜ calculated in the fifth process is referred to as “second loss”.

Specifically, given that “Nⁱⁿ(Iₜ)” denotes a set of vertices which serve as the heads of the branches which end at the vertex of the executed action Iₜ, the optimization processing unit 15 calculates the second loss l\hat{ }ₜ(i) based on the following equation (2).

$${\hat{ℓ}}_{t} ( i ) = \frac{{ℓ}_{t} ( i )}{{\sum }_{j ∈ {N}^{in} ( i )} {p}_{t} ( j )} 𝕀 \{ i ∈ {N}^{out} ( {I}_{t} ) \} for each i ∈ [ K ] \qquad ( 2 )$$

As the sixth process, the optimization processing unit 15 calculates the weight wₜ₊₁(i) which is used in the subsequent round (i.e., “t+1”th round) for each action candidate i. In this case, as shown in the following equation (3), the optimization processing unit 15 calculates the weight wₜ₊₁(i) based on: the second loss l\hat{ }ₜ; the weight wₜ at the t-th round; the sum Wt of the weights; the parameters η and β; and the number K of the action candidates.

$${w}_{t + 1} ( i ) = {w}_{t} ( i ) exp ( - η {\hat{ℓ}}_{t} ( i ) ) + \frac{e β}{K} {W}_{t} \qquad ( 3 )$$

Thereby, the optimization processing unit 15 updates the weights which are a part of the setting of the feedback graph for each round. Then, according to the equation (3), the optimization processing unit 15 determines the weights which are the setting of the feedback graph so that dynamic regret based on the second loss will be better in a sense. Determining the weights which are the setting of the feedback graph in this way allows to select the action in the second process so as to suppress the dynamic regret.

Next, the performance evaluation of the present disclosure algorithm will be described. Solving the online optimization problem according to the present disclosure algorithm provides the following upper bound for the loss if the feedback graph is strongly observable.

$$\tilde{O} ( \sqrt{α ST} )$$

If the feedback graph is weakly observable, the following upper bound is provided.

$$\tilde{O} ( {δ}^{\frac{1}{3}} {S}^{\frac{1}{2}} {T}^{\frac{2}{3}} )$$

Here, “S” is an integer obtained by adding 1 to the number of times the actions has changed for the sequence of actions to be compared, in the objective function, with the sequence of the determined actions. Besides, “T” represents the number of rounds, “α” represents the independence number of the feedback graph, and “β” represents the weak domination number of the feedback graph. It is noted that “a set of vertices is an independent set” means that there are no branches between any two points of the set of vertices. The independence number of the graph refers to the number of vertices in the largest independent set of the graph. The weak domination number of a graph refers to the number of vertices in the smallest weakly dominating set of the graph.

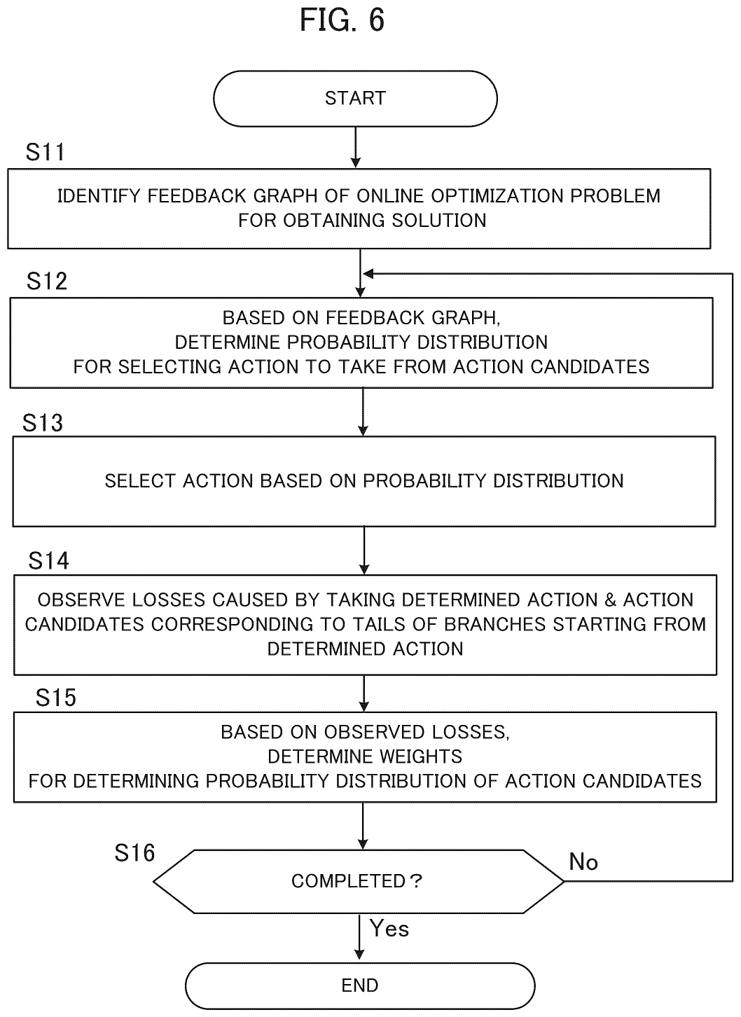

FIG. 6 is an example of a flowchart illustrating a processing procedure based on the present disclosure algorithm.

First, the information processing device 1 identifies a feedback graph representing the online optimization problem for obtaining a solution (step S11). In this case, for example, the information processing device 1 refers to the problem specification information and identifies the feedback graph.

Next, the information processing device 1 determines a probability distribution for selecting an action to be executed from the action candidates based on the classification of the feedback graph and the like (step S12). In this case, the information processing device 1 performs the first process described above and determines the probability distribution pₜ shown in the equation (1).

Next, based on the probability distribution determined at step S12, the information processing device 1 selects an action to be executed from the action candidates (step S13). In this case, the information processing device 1 performs the second process described above and probabilistically determines the action Iₜ.

Next, the information processing device 1 observes the losses caused by respectively taking the determined action Iₜ and the action candidates, which correspond to the vertices of the tails of the branches starting from vertex of the action Iₜ in the feedback graph (step S14). In this case, the information processing device 1 sequentially executes the third process and the fourth process described above to calculate the loss lₜ.

Next, the information processing device 1 determines, based on the losses observed at step S14, the weights to be used for determining the probability distribution of the action candidates at the subsequent round (step S15). In this instance, the information processing device 1 calculates the second loss l\hat{ }ₜ shown in the equation (2) by performing the fifth process described above, and then calculates the weight wₜ₊₁ shown in the equation (3) by performing the sixth process.

Next, the information processing device 1 determines whether or not to terminate the process of the flowchart (step S16). Upon determining that the process of the flowchart should be terminated (step S16; Yes), the information processing device 1 terminates the process of the flowchart. For example, upon determining that the current round is the last round to determine the action, the information processing device 1 terminates the process of the flowchart. The information processing device 1 may not execute the process at step S14 and step S15 at the last round.

On the other hand, upon determining that the process of the flowchart should not be terminated (step S16; No), the information processing device 1 proceeds back to the process at step S12 and performs the process at the subsequent round. For example, the information processing device 1 determines that the process of the flowchart should not be terminated if the current round is not the last round to determine the action.

### (5) Application Example

An example of the application of the online optimization problem is described.

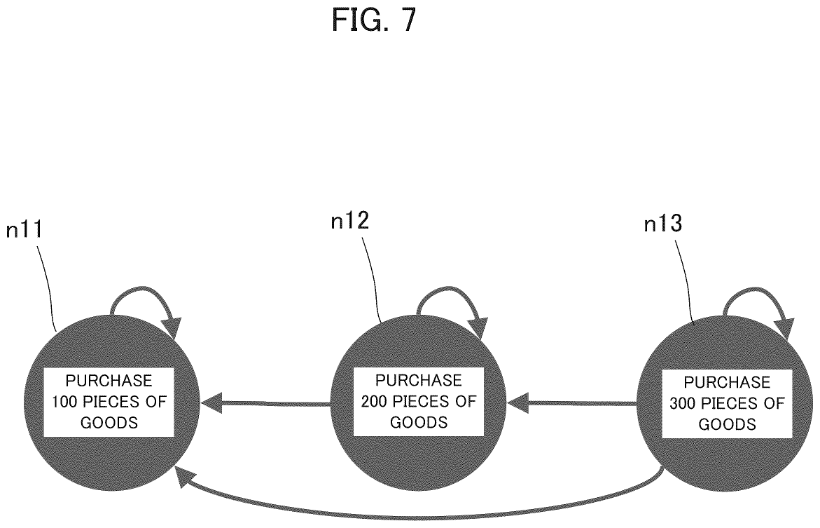

FIG. 7 is a feedback graph illustrating an example of the application regarding opportunity loss in retail sales. In this feedback graph, the vertex n11 represents the action to purchase 100 pieces of goods, the vertex n12 represents the action to purchase 200 pieces of goods, and the vertex n13 represents the action to purchase 300 pieces of goods.

If the action to purchase 300 pieces of goods is carried out, not only the result (at least including loss) of the action to purchase 300 pieces of goods but also the result of the action to purchase 200 pieces of goods and the result of the action to purchase 100 pieces of goods will be observed. Therefore, the vertex n13 has a self-loop and has branches reaching the vertex n11 and the vertex n12. Similarly, if the action of purchasing 200 pieces of goods is performed, not only the result of the action to purchase 200 pieces of goods but also the result of the action to purchase 100 pieces of goods will be observed. Thus, the vertex n12 has a self-loop and has a branch reaching the vertex n11. If an action to purchase 100 pieces of goods is performed, the result of the action to purchase 100 pieces of goods will be observed. Thus, the vertex n11 has a self-loop. It is noted that the feedback graph shown in FIG. 7 is strongly observable since every vertex has a self-loop.

Thus, an example of the application relating to an opportunity loss in a retailer's sales may also be suitably represented in a feedback graph, and the action to be performed can be determined based on the present disclosure algorithm.

### Second Example Embodiment

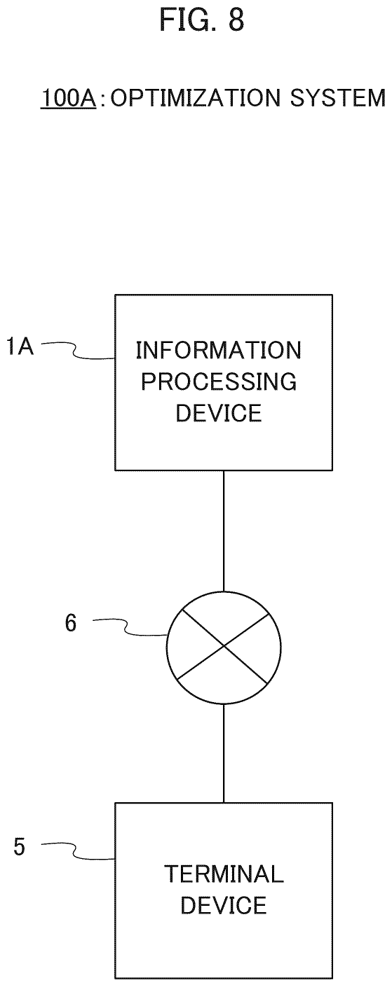

FIG. 8 shows the configuration of the optimization system 100A. The optimization system 100A mainly includes an information processing device 1A and a terminal device 5. The information processing device 1A and the terminal device 5 perform data communication via the network 6.

The information processing device 1A is one or more devices that function as a server (including a cloud server), and performs processing related to optimization performed by the information processing device 1 according to the first example embodiment. In this instance, the information processing device 1A receives the input information, which was received by the information processing device 1 from the input device 2 according to the first example embodiment, from the terminal device 5 via the network 6. Further, the information processing device 1A transmits the display information, which was set by the information processing device 1 to the display device 3 according to the first example embodiment, to the terminal device 5 via the network 6. The information processing device 1A stores the information, which was stored in the storage device 4 in the first example embodiment.

The terminal device 5 is a terminal having an input function, a display function, and a communication function, and functions as the input device 2 and the display device 3 in the first example embodiment. The terminal device 5 may be, for example, a personal computer, a tablet terminal, a PDA (Personal Digital Assistant), or the like. The terminal device 5 transmits input information generated based on the user input to the information processing device 1A through the network 6. Upon receiving the display information from the information processing device 1A, the terminal device 5 displays the information based on the display information.

The information processing device 1A according to the second example embodiment can suitably execute the input-processing and the output-processing executed by the information processing device 1 in the first example embodiment for the user of the terminal device 5.

### Third Example Embodiment

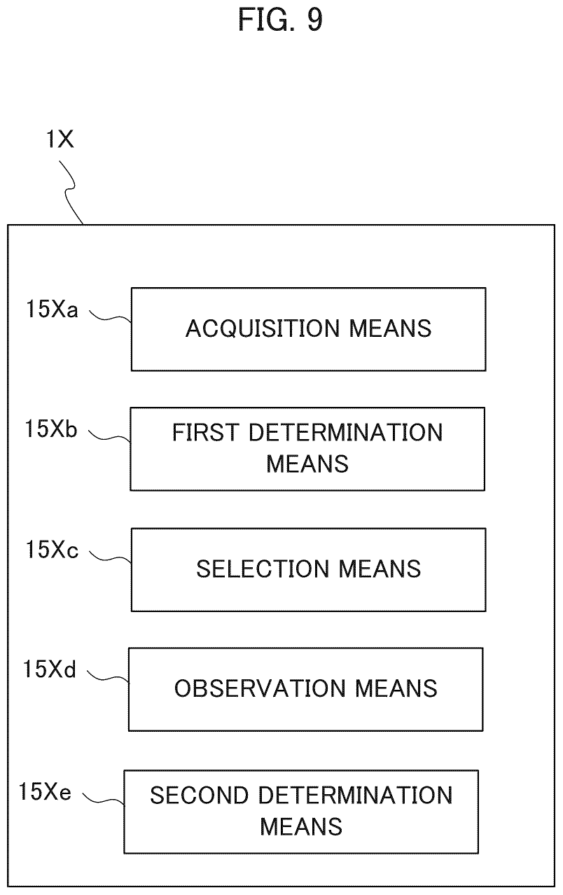

FIG. 9 is a functional block diagram of an information processing device 1X. The information processing device 1X mainly includes an acquisition means 15Xa, a first determination means 15Xb, a selection means 15Xc, an observation means 15Xd, and a second determination means 15Xe. The information processing device 1X may be configured by a plurality of devices.

The acquisition means 15Xa is configured to acquire a feedback graph representing an online optimization problem. The first determination means 15Xb is configured to determine, based on the feedback graph, a probability distribution for selecting an action to be taken from action candidates. The selection means 15Xc is configured to select the action based on the probability distribution. The observation means 15Xd is configured to observe a loss based on taking the action. The second determination means 15Xe is configured to determine, based on the observed loss, a weight for determining the probability distribution. The acquisition means 15Xa, the first determination means 15Xb, the selection means 15Xc, the observation means 15Xd, and the second determination means 15Xe can be implemented, for example, by the optimization processing unit 15 in the first example embodiment or the second example embodiment.

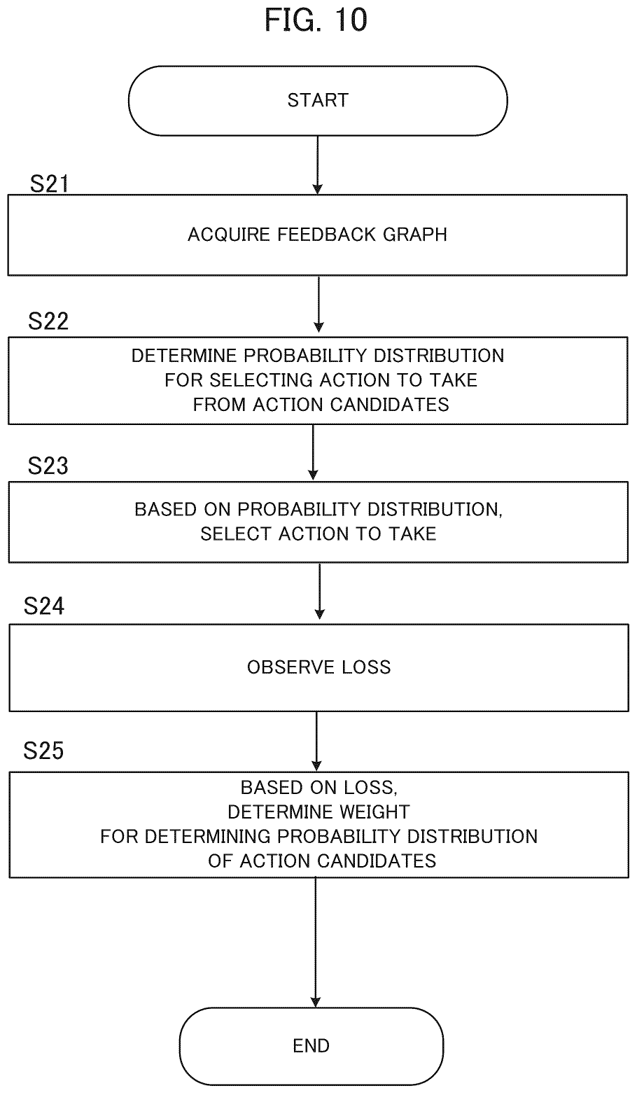

FIG. 10 is an example of the flowchart executed by the information processing device 1X. The acquisition means 15Xa acquires a feedback graph representing an online optimization problem (step S21). The first determination means 15Xb determines, based on the feedback graph, a probability distribution for selecting an action to be taken from action candidates (step S22). The selection means 15Xc selects the action based on the probability distribution (step S23). The observation means 15Xd observes a loss based on taking the action (step S24). The second determination means 15Xe determines, based on the observed loss, a weight for determining the probability distribution (step S25).

The information processing device 1X according to the third example embodiment can accurately determine the action to be taken in the online optimization problem.

In addition, some or all of the above-described example embodiments (including modifications, the same shall apply hereinafter) may also be described as follows, but are not limited to the following. Some or all of the configurations described in Supplementary Note 2 to Supplementary Note 8 which are dependent on Supplementary Note 1 may be dependent on Supplementary Note 9 and Supplementary Note 10 by the same dependence as Supplementary Note 2 to Supplementary Note 8. Furthermore, the invention is not limited to the devices, the methods, and the storage media described in Supplementary Notes. Any system, method, hardware, software, recording means (including the storage media) for recording the software may be equipped with some or all of the configurations described in Supplementary Notes, without departing from the above-described example embodiments.

### Supplementary Note 1

An information processing device comprising:
an acquisition means configured to acquire a feedback graph representing an online optimization problem;
a first determination means configured to determine, based on the feedback graph, a probability distribution for selecting an action to be taken from action candidates;
a selection means configured to select the action based on the probability distribution;
an observation means configured to observe a loss based on taking the action; and
a second determination means configured to determine, based on the loss, a weight for determining the probability distribution.

### Supplementary Note 2

The information processing device according to Supplementary Note 1,
wherein the weight is a setting of the feedback graph, and
wherein the second determination means is configured to update the weight at every round to determine the action.

### Supplementary Note 3

The information processing device according to Supplementary Note 1,
wherein the second determination means is configured to determine the weight to improve a dynamic regret based on the loss.

### Supplementary Note 4

The information processing device according to Supplementary Note 1,
wherein the observation means is configured to acquire, as the loss based on taking the action, a first loss caused by taking each of
   the action and
   an action candidate corresponding to a vertex to which a branch starting from the action connects.

### Supplementary Note 5

The information processing device according to Supplementary Note 4, further comprising
a calculation means configured to calculate a second loss based on the first loss and the probability distribution,
   wherein the second determination means is configured to determine the weight based on the second loss.

### Supplementary Note 6

The information processing device according to Supplementary Note 1,
wherein the first determination means is configured to determine the probability distribution based on classification of the feedback graph.

### Supplementary Note 7

The information processing device according to Supplementary Note 1,
wherein the acquisition means is configured to acquire the feedback graph by referring to a storage device which stores information regarding the feedback graph.

### Supplementary Note 8

The information processing device according to Supplementary Note 1, further comprising
wherein the at least one processor is configured to execute the instructions to cause a display device to display information regarding the selected action.

### Supplementary Note 9

A control method executed by a computer, comprising:
acquiring a feedback graph representing an online optimization problem;
determining, based on the feedback graph, a probability distribution for selecting an action to be taken from action candidates;
selecting the action based on the probability distribution;
observing a loss based on taking the action; and
determining, based on the loss, a weight for determining the probability distribution.

### Supplementary Note 10

A non-transitory computer readable storage medium storing a program executed by a computer, the program causing the computer to:
acquire a feedback graph representing an online optimization problem;
determine, based on the feedback graph, a probability distribution for selecting an action to be taken from action candidates;
select the action based on the probability distribution;
observe a loss based on taking the action; and
determine, based on the loss, a weight for determining the probability distribution.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1, 1A, 1X Information processing device
2 Input device
3 Display device
4 Storage device
5 Terminal device
100, 100A Optimization system

What is claimed is:

1. An information processing device comprising:
at least one memory configured to store instructions; and
at least one processor configured to execute the instructions to:
acquire a feedback graph representing an online optimization problem;
determine, based on the feedback graph, a probability distribution for selecting an action to be taken from action candidates;
select the action based on the probability distribution;
observe a loss based on taking the action; and
determine, based on the loss, a weight for determining the probability distribution.

2. The information processing device according to claim 1,
wherein the weight is a setting of the feedback graph, and
wherein the at least one processor is configured to execute the instructions to update the weight at every round to determine the action.

3. The information processing device according to claim 1,
wherein the at least one processor is configured to execute the instructions to determine the weight to improve a dynamic regret based on the loss.

4. The information processing device according to claim 1,
wherein the at least one processor is configured to execute the instructions to acquire, as the loss based on taking the action, a first loss caused by taking each of
the action and
an action candidate corresponding to a vertex to which a branch starting from the action connects.

5. The information processing device according to claim 4,
wherein the at least one processor is configured to execute the instructions to
calculate a second loss based on the first loss and the probability distribution, and
determine the weight based on the second loss.

6. The information processing device according to claim 1,
wherein the at least one processor is configured to execute the instructions to determine the probability distribution based on classification of the feedback graph.

7. The information processing device according to claim 1,
wherein the at least one processor is configured to execute the instructions to acquire the feedback graph by referring to a storage device which stores information regarding the feedback graph.

8. The information processing device according to claim 1,
wherein the at least one processor is configured to execute the instructions to cause a display device to display information regarding the selected action.

9. A control method executed by a computer, comprising:
acquiring a feedback graph representing an online optimization problem;
determining, based on the feedback graph, a probability distribution for selecting an action to be taken from action candidates;
selecting the action based on the probability distribution;
observing a loss based on taking the action; and
determining, based on the loss, a weight for determining the probability distribution.

10. A non-transitory computer readable storage medium storing a program executed by a computer, the program causing the computer to:
acquire a feedback graph representing an online optimization problem;
determine, based on the feedback graph, a probability distribution for selecting an action to be taken from action candidates;
select the action based on the probability distribution;
observe a loss based on taking the action; and
determine, based on the loss, a weight for determining the probability distribution.
